(19) United States
(12) Patent Application Publication
(10) Pub. No.: US 2015/0164010 A1
(43) Pub. Date: Jun. 18, 2015

(54) BUCKET CONVERSION SELF-WATERING PLANTER

(71) Applicant: WILLIAM JOSEPH WOOD, Conway, SC (US)

(72) Inventor: WILLIAM JOSEPH WOOD, Conway, SC (US)

(21) Appl. No.: 14/496,883

(22) Filed: Sep. 25, 2014

(51) Int. Cl. A01G 27/00; B09B 3/00; A01C 15/00

(52) U.S. Cl. CPC A01G 27/005; A01G 27/003; A01C 15/00; A01G 27/008; B09B 3/00

(57) ABSTRACT

This one-piece drop in device converts buckets into self-watering container systems used for growing plants. The device produces a bottom water reservoir and an upper area for soil. The device has a plurality of holes in its sides that allow soil to take up water by capillary action. The device can be manufactured using recycled materials and promotes going green. The pre-manufactured bucket will provide the side walls needed to stabilize and strengthen the drop in device.

This patent application claims priority from provisional patent application No. 61/970,164 filed Mar. 25, 2014.

### FIELD OF INVENTION

This invention relates to a plant container self-watering system, wherein the level of water is preferably kept uniform.

### BACKGROUND OF THE INVENTION

Self-watering systems for both plants and Christmas trees are known to the art. Thus mention can be made of the Main U.S. Pat. No. 6,497,071; and to Copenhaver U.S. Pat. No. 5,369,000; which relate to Christmas trees; while Buss, U.S. Pat. No. 6,357,179; Colovic U.S. Pat. No. 6,079,156; and Lishman U.S. Pat. No. 5,020,261; are typical examples of the prior art that relates to the self-watering of plants and planters.

The present invention, which is in the category of a plant watering system, enjoys the benefits of being both simple to use and low cost. It uses existing buckets in multiple sizes or any pre-manufactured inexpensive buckets sold at local retail stores. This makes for ease of moving from location to location.

### SUMMARY OF THE INVENTION

This present invention relates to plant growing systems, specifically to the portable self-watering systems with the water reservoir formed in the base of the container. This one piece drop-in device creates space for a bottom water reservoir, a lower center core of soil for wicking and a solid top rim that supports the upper soil.

The device has a plurality of holes that allow capillary action of water to the plants root system. The natural wicking process begins when the water that is in the bottom reservoir seeps through the wicking holes from all sides and into the lower center core zone soil. This wicking water continues to travel upwards through the soil replenishing moisture the plant uses to grow and thrive.

This growing system requires a drainage hole that is located in the side of the bucket just below the outer top support rim of the drop-in device and a filling tube that is used to add liquid as needed. This device provides a simple and economical way for people to grow fresh vegetables with minimal space or who have problematic soil.

### BRIEF DESCRIPTION OF THE IMAGES

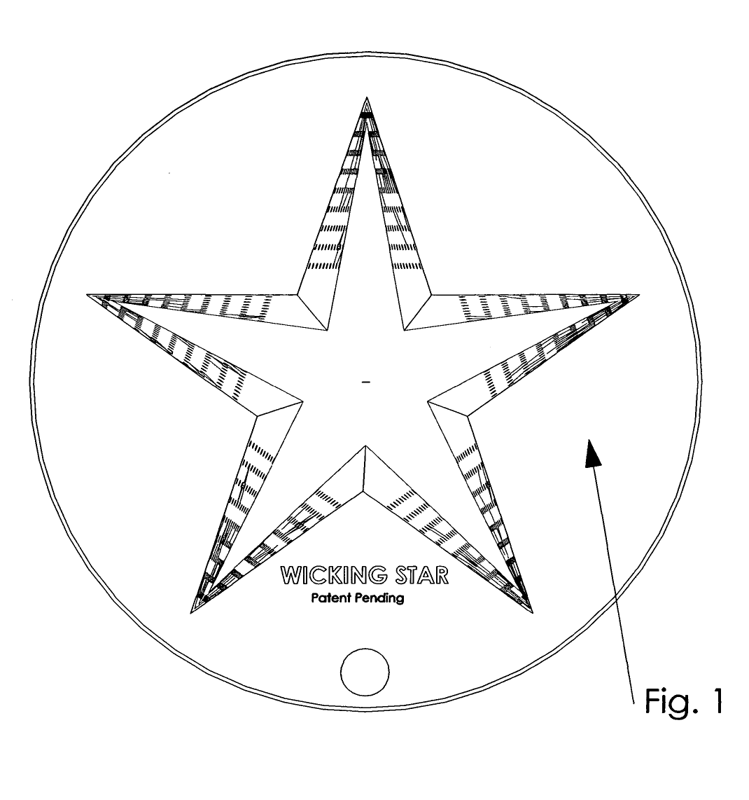

FIG. 1 is the top view of the device showing the outer top support rim.

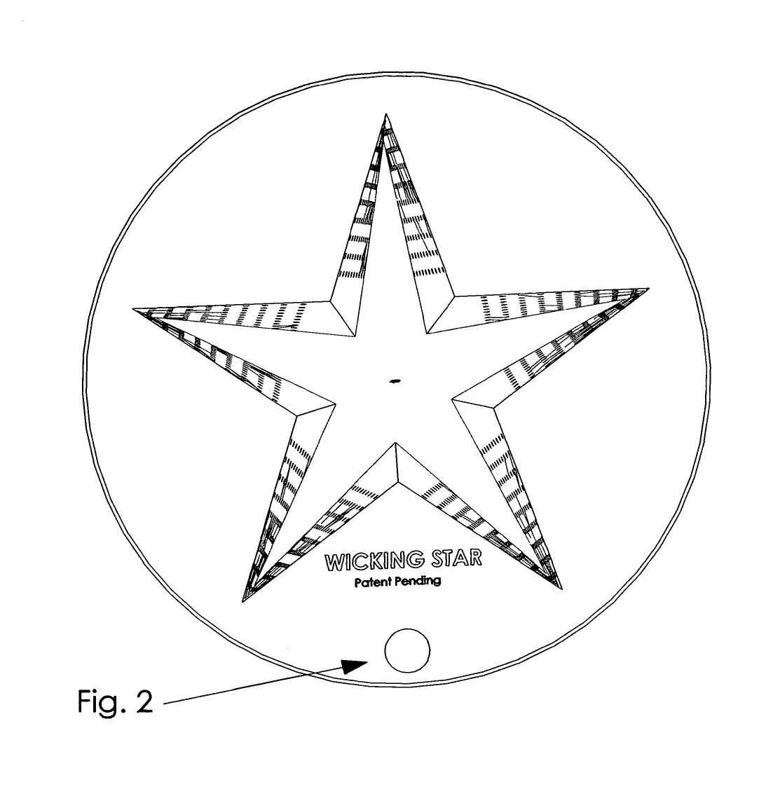

FIG. 2 is the hole for the water reservoir filling tube.

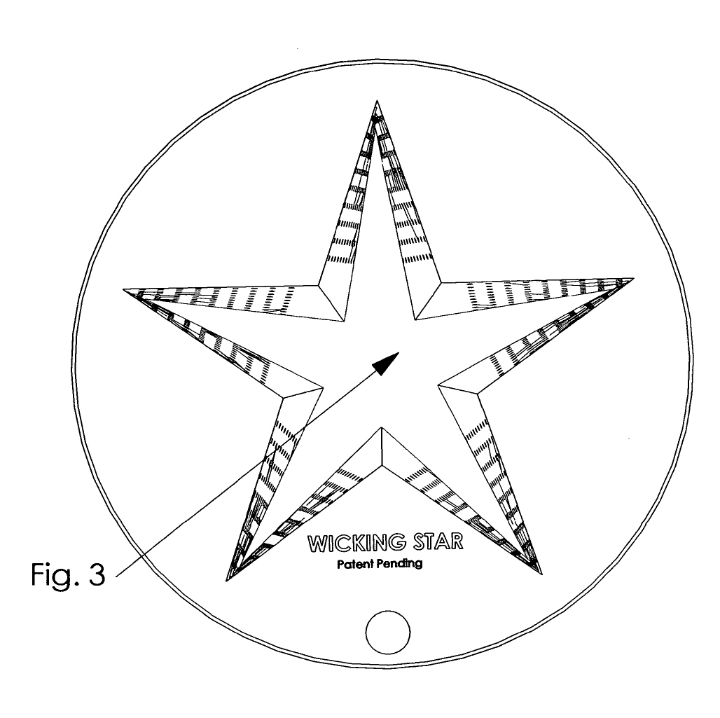

FIG. 3 is the lower center core zone used for the initial wicking process.

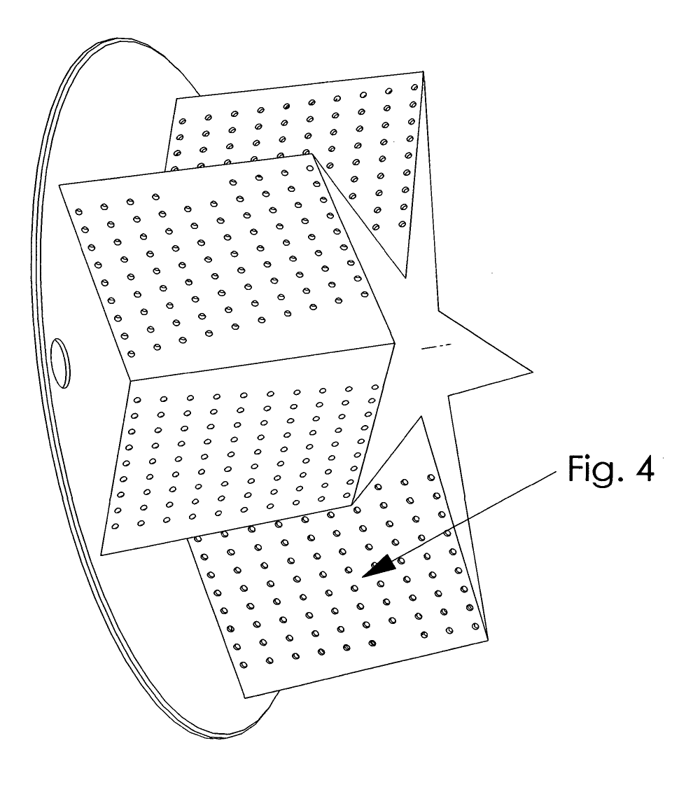

FIG. 4 is the side view showing plurality of wicking holes.

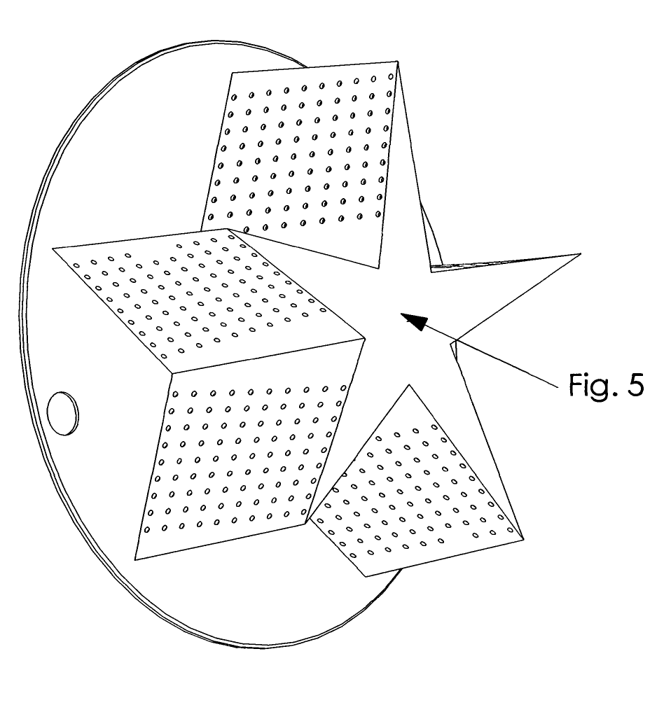

FIG. 5 is the star shaped wicking device.

### OBJECTS OF THE INVENTION

It is therefore an object of the invention to convert commercial pre-manufactured buckets into self-watering planters allowing days without the need of refilling of water.

It is a further object to be able to recycle and go green by using existing pre-manufactured buckets and/or containers.

It not only contributes to being green, but conserves water supply and principles by use of inexpensive items that are currently available.

I claim:

1. This one-piece drop in device will convert an existing bucket into a self-watering planter. Eliminating the need of daily watering which contributes to water conservation.

2. The solid top rim as shown in FIG. 1 will create an enclosure to reduce the evaporation of reservoir water directly into the atmosphere. This eliminates the need of daily watering of plants.

3. The ¾ inch hole shown in FIG. 4 is for a tube of any material or funnel to fill the water reservoir without removing the plant.

4. The solid molded bottom of any shape (example: star, circle, crescent, octagon) will set on the bottom of a bucket to separate soil from a water reservoir allowing water circulation and maintain soil weight of the core.

5. The sides walls of this device as shown in FIG. 9 creates an inner core of a minimum of 4 inches tall with a maximum that could differ depending on design shape. The shape must maintain a soil height that will create an open space for a bottom reservoir to allow circulation of water.

6. The walls have a plurality of holes shown in FIG. 6 that allows soil to take up water by capillary action.

7. The capillary action creates the wicking of water to travel upward to the roots of the plant as needed. Maintaining the proper moisture level a plant needs to grow.

8. That this device can be manufactured using recycled materials that will benefit in reduction of waste taken to landfills. This provides a green way to recycle existing pre-manufactured buckets into a self-watering planter.

9. This device will allow a novice gardener to grow fresh vegetables or plants in a limited space or area where problematic soil is found.
